(19) United States
(12) Patent Application Publication
(10) Pub. No.: US 2026/0296377 A1
(43) Pub. Date: Oct. 1, 2026

(54) VEHICLE INTERIOR CLEANING APPARATUS

(71) Applicant: Confinity Robotics, LLC, Chagrin Falls, OH (US)

(72) Inventor: Christopher D. Tomko, Butler, PA (US)

(21) Appl. No.: 19/636,719

(22) Filed: Apr. 1, 2026

Related U.S. Application Data
(60) Provisional application No. 63/781,617, filed on Apr. 1, 2025.

(51) Int. Cl. B60S 3/00; A47L 9/04; A47L 9/14

(52) U.S. Cl. CPC B60S 3/008; A47L 9/04; A47L 9/1409

(57) ABSTRACT

A cleaning apparatus includes a first housing that defines a passage having a cross-sectional area that progressively decreases in the direction of airflow from a cleaning interface toward an outlet port. A second housing is coupled to the first housing and defines a second passage that communicates with the first passage, the second passage likewise decreasing in cross-sectional area along the direction of airflow from the cleaning interface toward the first passage. A spinning assembly is positioned within at least one of the housings and includes a nozzle configured to discharge pressurized air into the second passage to induce turbulence and promote debris removal. As air moves through the narrowing passages, its velocity increases, enhancing the delivery of directed airflow to the cleaning interface and improving overall cleaning efficiency.

This application claims priority to U.S. Ser. No. 63/781,617, entitled VEHICLE INTERIOR CLEANING APPARATUS, filed Apr. 1, 2025, which is incorporated herein by reference.

### BACKGROUND

Cleaning of vehicle interiors at full-service car and vehicle wash operations are highly labor intensive and require multiple workers using a combination of sprays, wipes, squeegees, towels, air guns or other methods to remove dirt and debris from multiple surfaces, such as surfaces of the floor, seats, dashboard, console and various components of the door. Because many vehicle wash operations use conveyors to move vehicles through the interior cleaning operation quickly many in a matter of a few minutes-cleaning operations rely on multiple operators using a variety of separate hand tools to clean the various parts of the vehicles'interior.

Vacuuming is an important process used to clean vehicle floors and seating surfaces, including upholstery, and has been a very difficult operation to automate. This is due to the complex geometries of floors, seats, and their mating surfaces, narrow clearances between objects, and the high variability of surfaces from vehicle to vehicle. Further, if dirt or debris is tightly bound to a surface or is sticky or of high viscosity, a worker will typically rub or beat the surface with a purpose-built tool or the worker's hands to loosen or remove the debris. This operation can be rough on the surfaces. Additionally, such operations are difficult to mimic with a robot or automated tool without damaging the surfaces intended to be cleaned.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, a cleaning apparatus includes a first housing defining a first passage therethrough having a cross-sectional area that decreases along a direction of airflow from a cleaning interface to an outlet port, and a second housing coupled to the first housing and defining a second passage in communication with the first passage and also having a cross-sectional area that decreases along the direction of airflow. A spinning assembly disposed within at least one of the housings has a nozzle configured to expel pressurized air into the second passage to generate turbulence, and the decreasing cross-sectional areas increase the velocity of airflow moving toward the outlet port. The spinning assembly may be part of a removable cartridge assembly having a self-cleaning gap between the nozzle and a lower opening in the cartridge housing, through which air is drawn to prevent debris accumulation. The apparatus may include sensors, a controller, cleaning bristles, a protective cone cover about the nozzle, an interior ramp defining a helical airflow path, and vacuum vents to balance pressures within the apparatus. The cleaning apparatus may be configured for attachment to a robotic arm for automated vehicle interior cleaning or as a handheld tool for manual operation.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a side view of an exemplary cleaning apparatus.

FIG. 2 is a front view of an exemplary cleaning apparatus.

FIG. 3 is a cross sectional view of the cleaning apparatus.

FIG. 4A is a volumetric schematic of the cleaning apparatus.

FIG. 4B is a volumetric cross-sectional area schematic of the cleaning apparatus.

FIG. 5A is a partial detailed view of the cartridge assembly.

FIG. 5B is another partial detailed view of the cartridge assembly.

FIG. 5C is another detailed view of the cartridge assembly.

FIG. 6A is a view of the cleaning apparatus illustrating a sensor location.

FIG. 6B is a detailed view of the sensor location of FIG. 6A.

FIG. 7 is a bottom view of the end-effector attachment.

FIG. 8A is a close-up view of the interior volume of the end-effector attachment.

FIG. 8B is a cross-sectional view of the interior of the end-effector attachment.

FIG. 9 is a close-up view of the bristle member received in the end-effector attachment.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

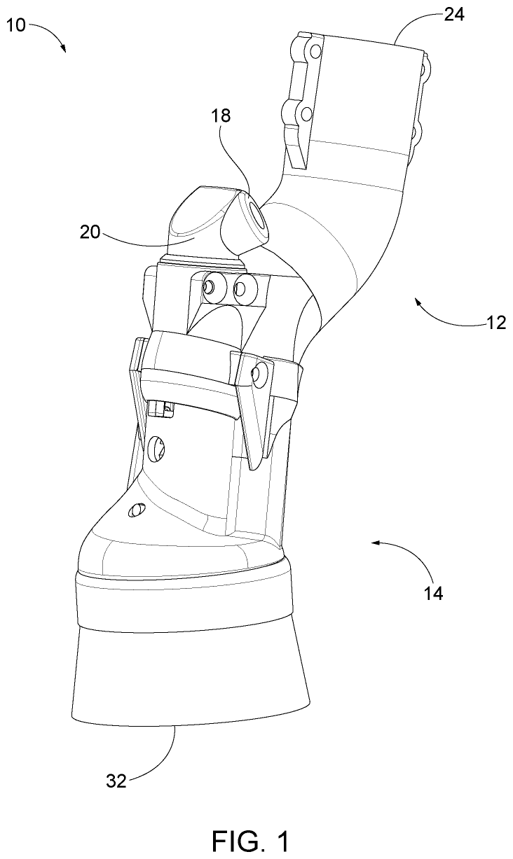

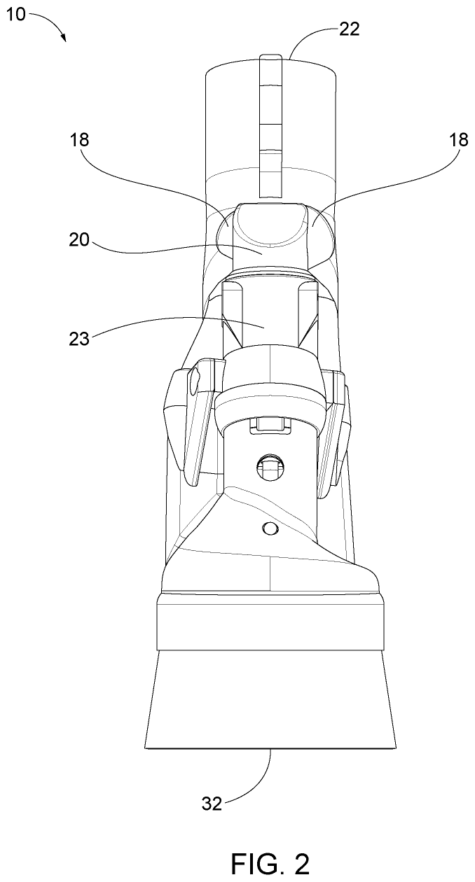

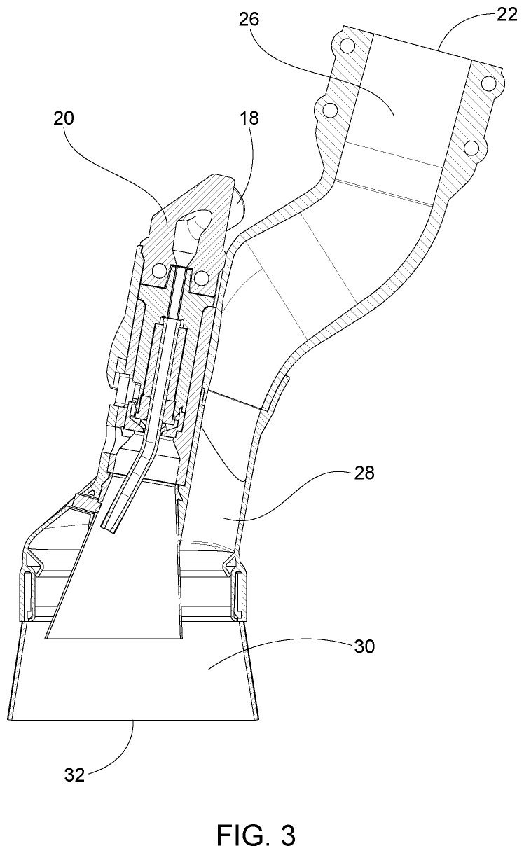

Turning initially to FIGS. 1-3, an exemplary cleaning apparatus is shown generally at reference numeral 10. The cleaning apparatus 10 includes a rigid first housing 12, a flexible second housing 14 coupled to the first housing 12, and a cartridge assembly 16 receivable within the first housing 12 and second housing 14. The second housing 14 may be coupled to a lower portion of the first housing 12 and extend downwardly therefrom toward the targeted cleaning surface. The housing includes at least one inlet port 18 configured to receive an air inlet 20 for receiving compressed air from an external source, and at least one fluid outlet port 22 configured to be coupled to a vacuum source via a hose or conduit.

The first housing 12 includes rigid housing portions coupled to flexible bell-shaped portions of the second housing 14. The first housing 12 provides the primary structural framework of the cleaning apparatus 10. The first housing 12 may be formed from a suitable material, such as a polymer, a composite material, a metal, or a combination thereof.

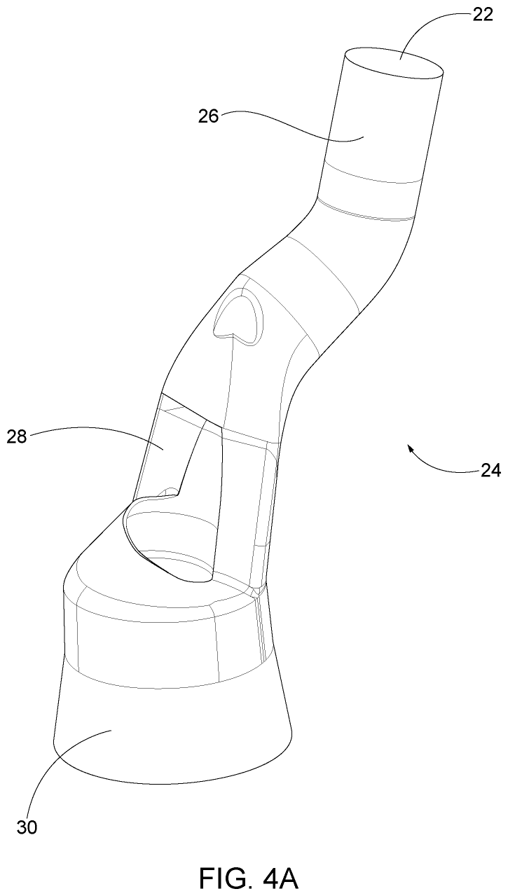

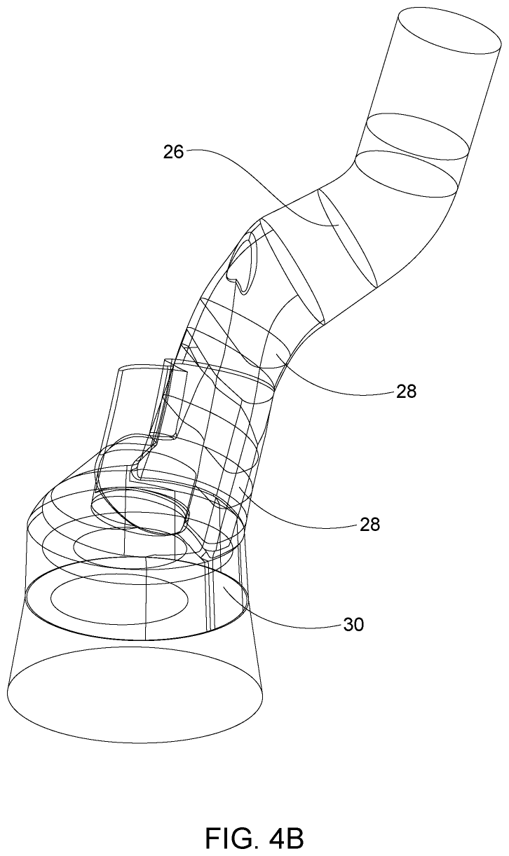

As shown in FIG. 4A-4B, the first housing 12 is coupled to the second housing 14 and defines a passage 24 through the interior of the second housing 14 to the outlet port 22 which is coupled to the vacuum source. The cross-sectional area of the passage 24 varies along its length, defining a plurality of zones configured to optimize airflow velocity and debris removal. For illustration, the passage 24 defines three zones.

A first zone of the passage 24 is disposed at an upper portion of the housing 26 and is configured to transfer the airflow from the second housing 14 to the hose or conduit coupled to the outlet port 22. A second zone of the passage 24 is disposed below the first zone and defines a middle portion 28 with a reduced cross-sectional area relative to the first zone, thereby constricting the airflow to create a higher velocity region. This increased velocity aids in the entrainment and transport of debris from the second housing 14 toward the outlet port 22. A third zone of the passage 24 is disposed below the second zone and defines a lower portion 30 of the second housing 14. The cross-sectional area of the third zone is greater than second such that the volume decreases from the third zone to the second zone, and then increases from the second zone to the first zone. The relative cross-sectional areas of the first, second, and third zones of the passage 24 may be selected to balance air velocity and the overall width of the cleaning opening for optimized cleaning coverage.

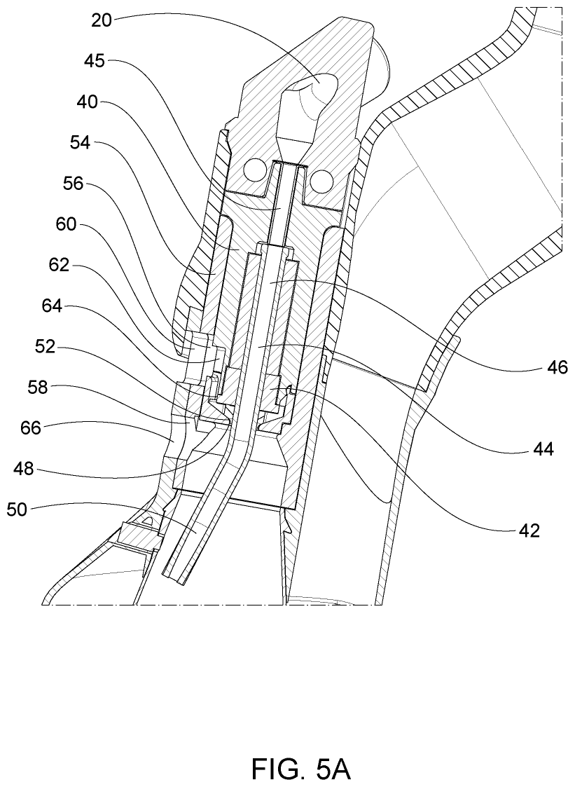

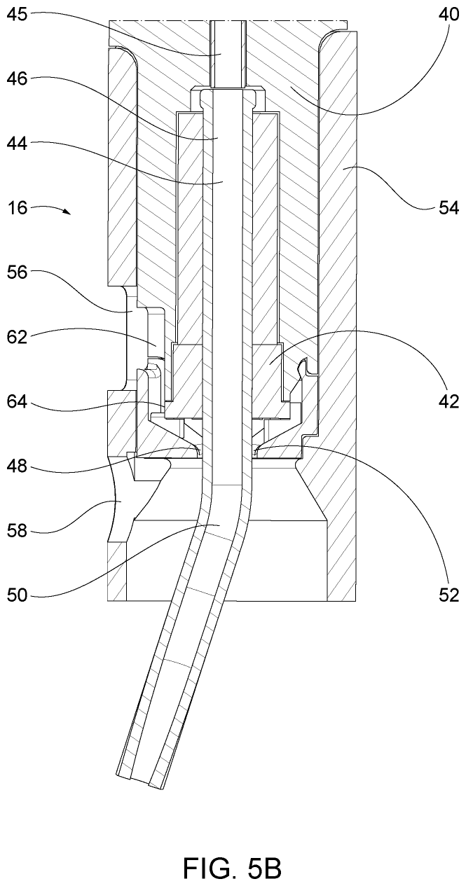

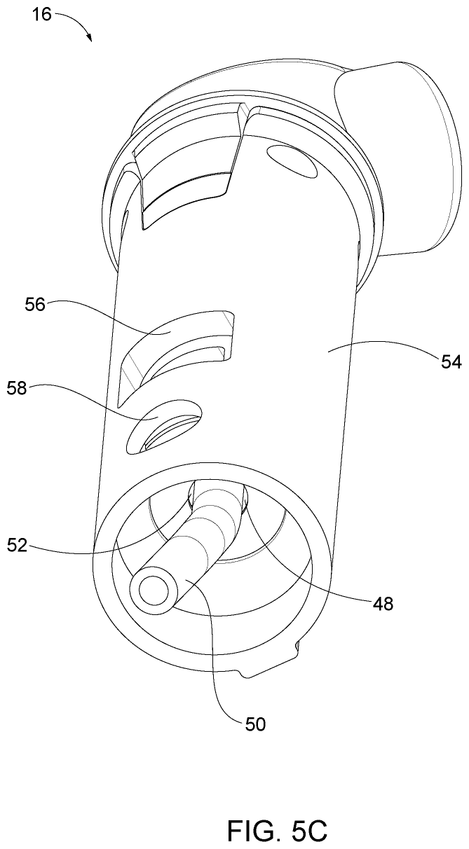

As shown in FIG. 5A-5C, the first housing 12 receives a removable cartridge assembly 16 in a passage 23 at the inlet port 18. The cartridge assembly 16 includes an upper housing 40, a lower housing 42 coupled to the upper housing 40, and a spinning assembly 44 disposed therebetween. The upper housing 40 includes a passage 45 at a first end in communication with the air inlet 20 and a cavity 46 opening to a second end for receiving the spinning assembly 44. The lower housing 42 includes a lower opening 48 extending therethrough where a portion of the spinning assembly 44 is received in the lower opening 48 at a first end and a nozzle 50 of the spinning assembly 44 extends through with the lower housing 42 into the lower portion passage 30 of the second housing 14.

During operation, pressurized air is delivered to and expelled by the nozzle 50 within the second housing 14, thereby generating turbulence at the cleaning interface 32. The turbulence may be in a circular vortex motion. The nozzle 50 may direct air under pressure toward the targeted cleaning surface in a rotating or helical pattern in a straight or generally on-direction stream, or in an irregular or non-patterned manner. The nozzle 50 may spin freely within the cartridge assembly 16 about a longitudinal axis thereof. The nozzle 50 of the spinning assembly 44 defines an aperture through which compressed air is expelled toward the targeted cleaning surface. The nozzle 50 may be straight relative to the longitudinal axis of the cartridge assembly 16. The nozzle 50 may be angled relative to the longitudinal axis of the cartridge assembly 16 to impart a helical or spiraling trajectory to the expelled air stream. The angle of the nozzle 50 may be selected to achieve a desired vortex diameter and rotational velocity at the cleaning interface 32. The distance of the nozzle 50 relative to the cleaning interface may also be selected to achieve a desired vortex diameter and rotational velocity. The nozzle 50 may include a plurality of apertures disposed at various angles to distribute the air stream across a broader area of the targeted cleaning surface. The nozzle 50 may be formed from a wear-resistant material, such as a hardened polymer or any other suitable material to withstand the abrasive effects of debris entrained in the airflow.

A gap 52 is provided between the nozzle 50 and the lower opening 48 providing a self-cleaning area. Air may be drawn through the self-cleaning gap 52 by the combination of vacuum pressure present within the second housing 14 and the low pressure zone created by the high-velocity airflow expelled from the nozzle 50. This airflow through the self-cleaning gap 52 prevents accumulation of debris within the cartridge assembly 16 and around the nozzle 50, thereby maintaining operational efficiency of the cleaning apparatus 10.

A shell 54 may also be provided with the cartridge assembly 16 or be coupled to the first housing 12. The shell 54 has a passage extending therethrough for receiving the cartridge assembly 16 and includes a vacuum inlet 56 serving as a self-cleaning feature and at least one vacuum vent 58 serving as a balancing feature. The vacuum inlet 56 is in communication with a corresponding inlet 60 in the second housing 14, the upper housing 62, and the lower housing 64 to all be in communication with the gap 52 between the nozzle 50 and lower opening 48. The vacuum vent 58 is in communication with a corresponding vent in the second housing 14 to be in communication with the passage in the second housing 14.

The vent 58 may be in the form of gill-like openings shaped to maintain the direction of the vortex flow within the second housing 14. When in operation, the high-velocity air expelled from the nozzle 50 creates a venturi effect at the vacuum vent 58, drawing ambient air inward through the vent 58 and into the second housing 14. The introduction of ambient air through the vent 58 increases the overall airflow within the second housing 14 and contributes to balancing the positive and negative pressures within the cleaning apparatus 10. The vent 58 further aids in preventing the cleaning apparatus 10 from clamping, suctioning, or locking onto the targeted cleaning surface due to excessive vacuum pressure. The balancing feature is configured to not interfere with the synchronized venturi action within the second housing 14. This is of particular importance when the cleaning apparatus 10 is mounted to a robotic arm, as clamping forces could overpower the robot's motors or trigger safety sensors that activate a power-down sequence to prevent damage.

The spinning assembly 44 is configured to rotate freely in response to pressurized air flowing through the air inlet 20 through the upper housing 40, thereby generating a spinning air stream that is directed toward a targeted cleaning surface. The cartridge assembly 16 is configured to channel compressed air and/or fluid received at the inlet port 18 downward through the spinning assembly 44, where the air is expelled from the nozzle 50 toward the targeted cleaning surface. The cartridge assembly 16 is configured for tool-free removal and replacement, thereby permitting rapid servicing of the nozzle 50, which is a wear component that includes bearings that may require periodic replacement.

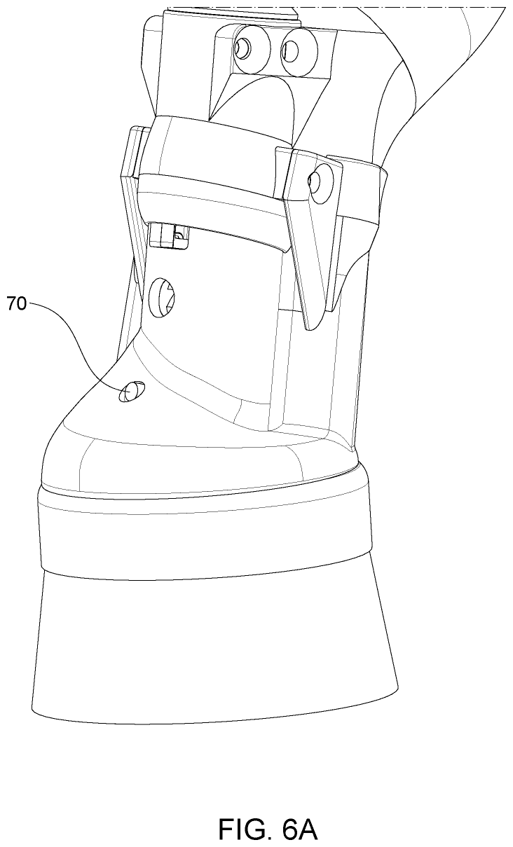

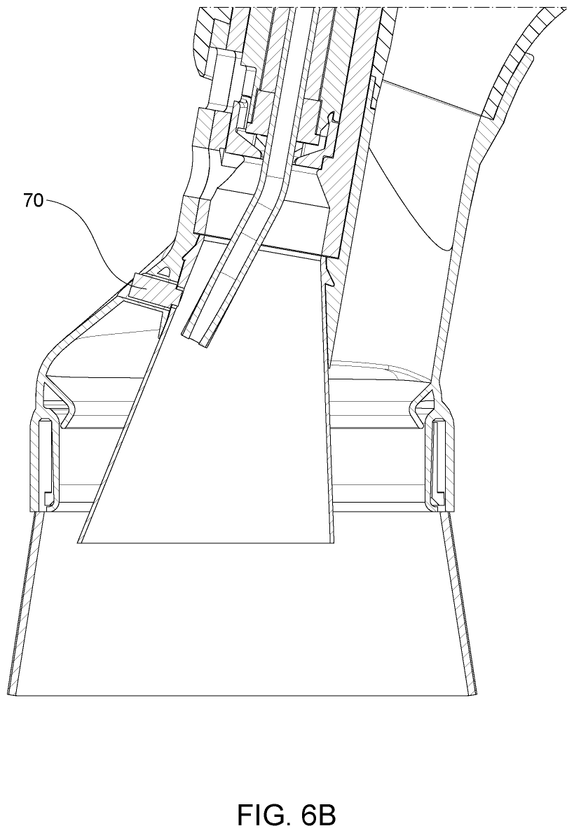

Turning now to FIGS. 6A and 6B, at least one sensor 70 is disposed on or in the second housing 14 at a position configured to detect the rotational status of the nozzle 50. The sensor 70 may be a proximity sensor, a Hall effect sensor, an optical sensor, or any other sensor suitable for detecting proximity or motion. The sensor 70 is configured to provide a signal to a controller indicating whether the nozzle 50 is rotating, has slowed below a threshold rotational speed, has stopped, or debris is blocking the sensor 70 thus likely interfering with the nozzle 50. The sensor may send signals indicating whether a secondary tool is properly mated to this end effector. This feedback enables the controller to alert an operator or to initiate corrective action, such as pausing a robotic cleaning sequence, when the nozzle 50 is not operating as expected.

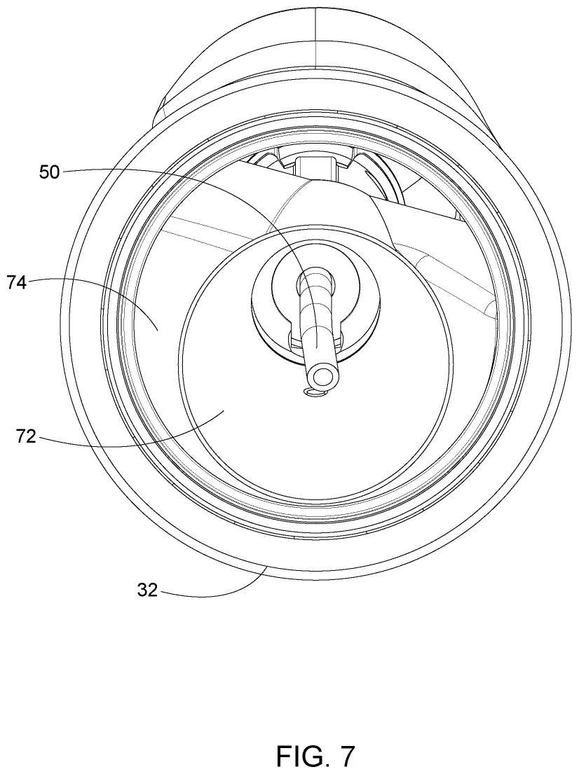

Turning to FIG. 7, the second housing 14 may be substantially bell-shaped, defining an interior volume that is in fluid communication with the outlet port 22. The bell-shaped configuration of the second housing 14 establishes an enclosed region proximate to the targeted cleaning surface, within which turbulent airflow may be generated to dislodge and entrain debris. The perimeter of the cleaning interface 32, which defines the opening closest to the targeted cleaning surface, may be sized to maximize the cleaning surface area engaged during each pass of the cleaning apparatus 10.

The second housing 14 may include a protective cone cover 72 disposed concentrically about the nozzle 50. The narrower portion of the cone cover 72 may be affixed at its edge to the inside of the second housing 14 abutting the lower portion of the cartridge assembly 16 surrounding the lower opening 48 encompassing the nozzle 50. The protective cone cover 72 may have a height equal to, less than, or greater than the length of the rotating parts of the nozzle 50. The protective cone cover 72 shields the nozzle 50 from contact or collision with debris circulating within the second housing 14. In particular, the protective cone cover 72 may prevent sheet-like debris, such as leaves or pieces of paper, from draping over and impeding the rotation of the nozzle 50. The protective cone cover 72 may also prevent fiber-like debris, such as hair, from wrapping around the shaft of the nozzle 50 and accumulating to the point of impeding rotational motion. The protective cone cover 72 may additionally serve as a barrier to separate the airflow exiting the nozzle 50 from the airflow vacuumed through the passage 24 toward the outlet port 22. The protective cone cover 72 may include fin-type structures or grooves disposed on an interior surface thereof, configured to further increase the efficiency of airflow through the second housing 14. The cross-sectional area of the passage 24 may be further reduced by the protective cone cover 72 disposed about the nozzle 50, which effectively narrows the available flow path and increases the air velocity in the region surrounding the nozzle 50. Alternatively, the protective cone cover 72 may have a variable length, for example by omitting a portion to provide a more open passage in the lower portion of the end effector with a greater cross-sectional area.

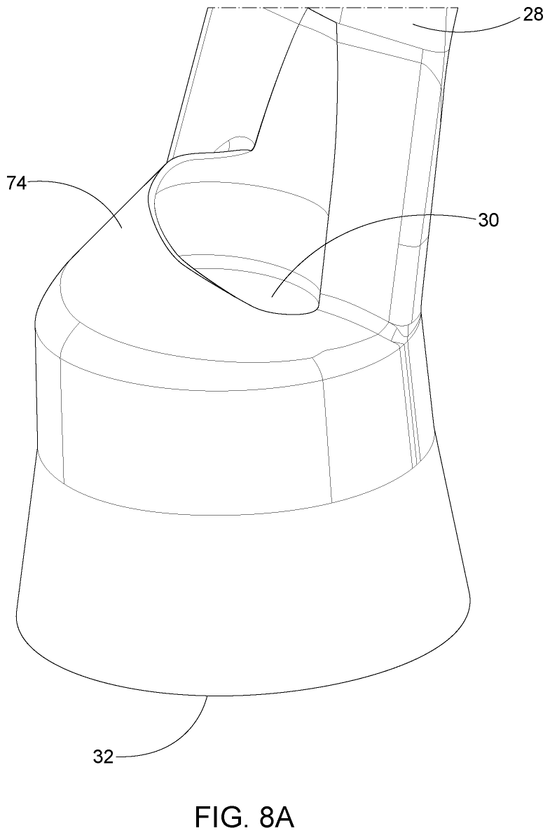

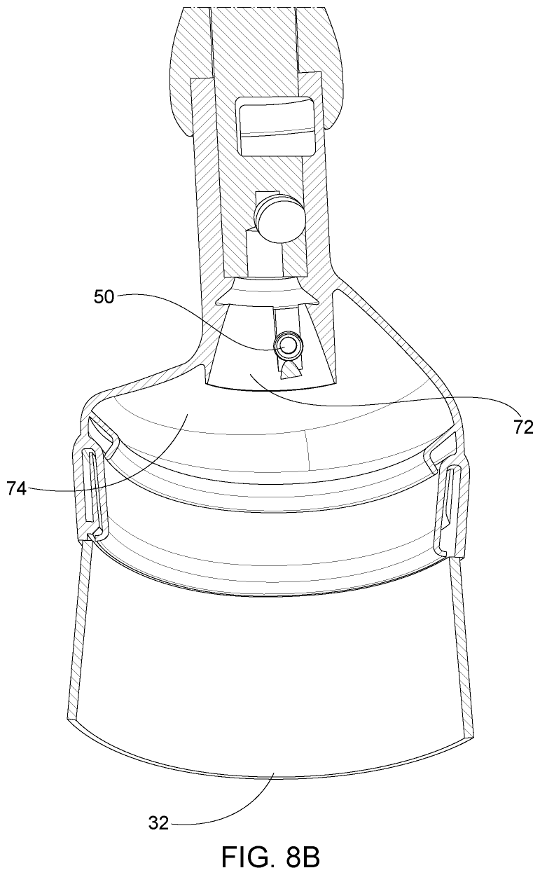

Turning now to FIG. 8A and FIG. 8B, the second housing 14 has a bell-shape such that there is a gradually increasing cross-sectional area, thereby accommodating a larger vacuum opening proximate to a cleaning interface 32. The cleaning interface 32 is defined by an opening configured to be positioned proximate to a targeted cleaning surface during operation. As discussed above, the increased opening in the third zone facilitates the intake and removal of larger debris items from the targeted cleaning surface. The second housing 14 may include an interior ramp 74 that blocks a portion of the interior volume adjacent to the passage of the middle portion 28 of the housing such that the volume of the lower portion 30 of the second housing 14 defined by the interior region has an inverse relationship with the velocity of the airflow being drawn toward the outlet port 22 by the vacuum source. That is, a reduction in the interior volume of the second housing 14 may increase the velocity of airflow through the outlet port 22. The ramp 74 may be a partition within the second housing 14, thereby reducing the effective volume and directing airflow toward the outlet port 22. The ramp 74 may define a sloped egress that may be helical, nautilus-like, tapered, conical, or otherwise contoured, and is configured to direct airflow. The ramp 74 in a helical or nautilus-like shape may direct airflow in a rotational path that is synchronized with the vortex pattern generated by the nozzle 50. This synchronized airflow pattern may minimize energy loss at the interface between the nozzle 50, the cleaning interface 32, and the outlet port 22.

The interior ramp 74 may define an interior surface within the second housing 14 that corkscrews upward into the first housing 12 in a substantially helical or nautilus-like path, creating a progressively smaller cross-sectional area as the airflow progresses toward the outlet port 22, described above as the transition from zone 3 to zone 2. The ramp 74 interacts with the airflow generated by the nozzle 50 by directing the airflow in the same rotational direction as the vortex pattern of the nozzle 50, thereby creating a mild vortex within a lower portion of the passage 30. The helical geometry of the ramp 74 may further increase the velocity of the airflow moving toward the outlet port 22 by progressively constricting the flow path toward the middle portion 28 of the housing. The angle, shape, surface material, and surface texture of the ramp 74 may each be selected to optimize the velocity and directionality of the airflow, thereby enhancing the debris removal capability of the cleaning apparatus 10.

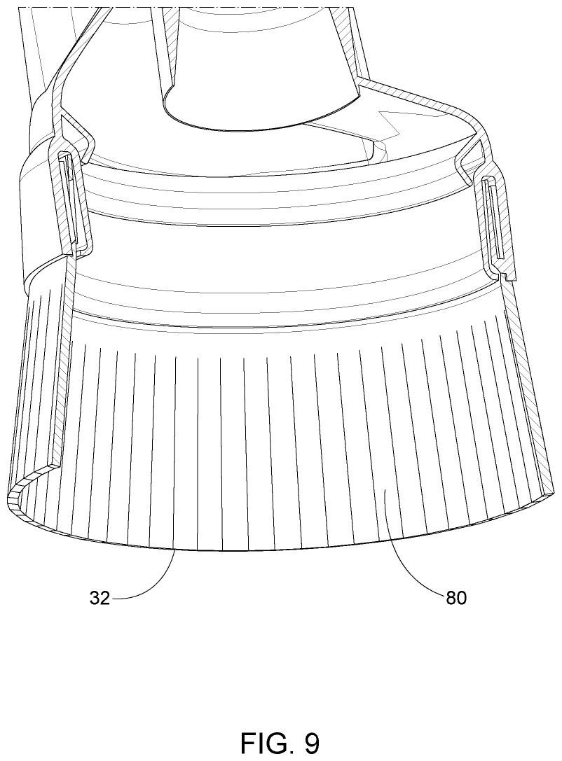

Generally shown in FIG. 9, the cleaning interface 32 may include cleaning bristles 80 disposed about the perimeter thereof. The cleaning bristles 80 may be formed from an elastomeric material and may be configured to contact the targeted cleaning surface during operation, thereby aiding in the dislodging of debris. The cleaning bristles 80 may have various cross-sectional shapes, including but not limited to circular, rectangular, triangular, or oval shapes. The cross-sectional shape of the cleaning bristles 80 may be selected to achieve a desired stiffness characteristic. The thickness of the cleaning bristles 80 may vary along their length to allow for flexibility at distal tips thereof, which contact the targeted cleaning surface, while providing rigidity at proximal portions thereof that are coupled to the second housing 14.

The cleaning bristles 80 may be removably coupled or permanently affixed to the perimeter of the cleaning interface 32. The cleaning bristles 80 may be removably coupled to the perimeter of the lower edge of the bell-shaped second housing 14, thereby permitting replacement and interchange of the cleaning bristles 80 as they become worn or as different bristle configurations are desired for different cleaning applications.

In general, the cleaning apparatus 10 is configured for attachment to a robotic arm and for use in confined spaces, such as vehicle cabins. The cleaning apparatus 10 may include one or more sensors 70 disposed on or within the first housing 12 or the second housing 14. The sensors 40 may be configured to detect proximity to the targeted cleaning surface, measure environmental conditions, or provide positional feedback, thereby enabling planning of robotic motions and toolpaths. In the robotic configuration, the cleaning apparatus 10 may be maintained at a predetermined distance above the targeted cleaning surface, which simplifies motion planning complexity and reduces the risk of contact between the cleaning apparatus 10 and interior surfaces of the vehicle. The cleaning apparatus 10 may also be configured as a handheld tool for manual use by an operator.

The cleaning apparatus 10 may include also a vacuum pressure sensor configured to measure the vacuum pressure within the first housing 12, the second housing 14, or a conduit coupled to the outlet port 22. The vacuum pressure sensor may be an inline sensor disposed along the fluid pathway and configured to provide real-time pressure feedback to a controller. The vacuum pressure sensor may be disposed at a location along the fluid pathway between the second housing 14 and the vacuum source, such as within or adjacent to the outlet port 22, or along a conduit coupled to it. The vacuum pressure sensor may be a piezoresistive sensor, a capacitive sensor, a strain gauge sensor, or any other type of pressure transducer suitable for measuring vacuum pressure within the operating range of the cleaning apparatus 10. The controller may use the pressure data from the vacuum pressure sensor to optimize the balance between the positive pressure from the inlet port 18 and the negative pressure from the vacuum source, and to detect conditions such as a clogged conduit or a loss of vacuum pressure.

The cleaning apparatus 10 may include a digital airflow sensor configured to measure the rate or velocity of airflow within the cleaning apparatus 10. The digital airflow sensor may be disposed at a location that does not substantially obstruct the primary fluid pathway, such as at an auxiliary port on the first housing 12. The digital airflow sensor may be a hot-wire anemometer, a vane-type sensor, a differential pressure sensor, or any other type of airflow transducer suitable for measuring airflow characteristics within the cleaning apparatus 10. In one configuration, the digital airflow sensor may be positioned at a dedicated monitoring port, and the controller may be configured to detect a clog condition by comparing the airflow rate at the monitoring port to a baseline value; for example, a significant increase in airflow at the monitoring port when another port is blocked may be indicative of a clog in the primary fluid pathway. The digital airflow sensor may be communicatively coupled to the controller and configured to provide continuous or periodic airflow data for real-time monitoring and closed-loop control of the cleaning operation.

The cleaning apparatus 10 may include a controller configured to receive signals from one or more of the sensors 70, the digital vacuum pressure sensor, and the digital airflow sensor. The controller may be a programmable logic controller, a microcontroller, a field-programmable gate array, or any other suitable processing device. The controller may be disposed within or on the first housing 12, or may be located remotely and communicatively coupled to the cleaning apparatus 10 by wired or wireless communication. The controller may be configured to execute one or more control routines, including a pressure optimization routine in which the controller adjusts the balance between the positive pressure from the inlet port 18 and the negative pressure from the vacuum source based on feedback from the digital vacuum pressure sensor, a clog detection routine in which the controller identifies a blockage in the fluid pathway based on data from the digital airflow sensor, and a spinner monitoring routine in which the controller determines whether the nozzle 50 is operating within a predetermined rotational speed range based on feedback from the sensors 70. The sensor(s) may also be used to indicate distance from a targeted cleaning surface or presence of ancillary tools that could be enjoined to the end effector attachment 14. When a fault condition is detected, the controller may generate an alert signal to an operator, pause a robotic cleaning sequence, or adjust operating parameters to restore normal operation.

The nozzle 50 may have controlled movement toward and away from the targeted cleaning surface along a longitudinal axis of the cartridge assembly 16. Movement of the nozzle 50 toward the targeted cleaning surface decreases the distance between the nozzle 50 and the cleaning interface 32, thereby decreasing the diameter of the impacted target surface and affecting the airflow dynamics and velocity within the second housing 14. Conversely, movement of the nozzle 50 away from the targeted cleaning surface increases the impacted area. The controlled movement of the nozzle 50 may be implemented by a pneumatic actuator, an electric motor, a spring mechanism, mechanical slides with clamps, a rack-and-pinion mechanism, or a hole-and-pin arrangement. The pneumatic actuator may be disposed within or coupled to the first housing 12 and configured to translate the nozzle 50 along the longitudinal axis of the cartridge assembly 16 in response to a control signal from the controller. The pneumatic actuator may include a cylinder and piston arrangement in communication with a source of compressed air, and may be configured to provide a predetermined range of travel sufficient to adjust the distance between the nozzle 50 and the cleaning interface 32. The pneumatic actuator may move the nozzle 50 alone, or may move the nozzle 50 and the protective cone cover 72 as an assembly.

In some embodiments, the first housing 12, the shell 54, and the upper housing 40 may include one or more sight glass ports disposed therethrough. The sight glass ports may be formed from a transparent or translucent material, such as polycarbonate, tempered glass, or acrylic, and may be sealed within corresponding openings in the first housing 12, the shell 54, and the upper housing 40 to maintain the fluid integrity of the cleaning apparatus 10. The sight glass ports may be disposed at a plurality of circumferentially spaced locations about the first housing 12 to permit observation of the spinning assembly 44 from multiple vantage points. The sight glass ports are configured to provide a visual indication of the rotational speed and operational status of the spinning assembly 44 without requiring disassembly of the cleaning apparatus 10. An operator may visually observe the spinning assembly 44 through the sight glass ports to quickly gauge whether the spinning assembly 44 is rotating at an expected speed or has stopped. The sight glass ports are of particular utility when the cleaning apparatus 10 is mounted to a robotic arm in a pose that obscures direct observation of the spinning assembly 44. The sight glass ports may also be advantageous in handheld configurations, enabling the operator to glance at the sight glass ports during use to confirm real-time performance of the spinning assembly 44.

In an exemplary method of use, the cleaning apparatus 10 is coupled to a robotic arm and positioned within a vehicle cabin. Compressed air is supplied to the air inlet 20 through the inlet port 18, and the vacuum source is activated at the outlet port 22. The nozzle 50 rotates in response to the compressed air. The nozzle 50 directs a spinning air stream toward the targeted cleaning surface. Simultaneously, the vacuum source draws debris-laden air upward through the passage 24 and out through the outlet port 22. The controller monitors signals from the sensors, the digital vacuum pressure sensor, and the digital airflow sensor to optimize cleaning performance and detect fault conditions. The robotic arm traverses the cleaning apparatus 10 across the targeted cleaning surface in a predetermined path, and the cleaning bristles 80, when present, aid in containing the cleaning zone and dislodging debris. Upon completion of a cleaning cycle, the cartridge assembly 16 may be removed and serviced as needed.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A cleaning apparatus, comprising:
a first housing defining a first passage therethrough, the first passage having a cross-sectional area that decreases along a direction of airflow from a cleaning interface to an outlet port;
a second housing coupled to the first housing and defining a second passage therethrough, the second passage being in communication with the first passage and having a cross-sectional area that decreases along the direction of airflow from the cleaning interface to the first passage; and
a spinning assembly disposed within at least one of the first and second housing and having a nozzle configured to expel pressurized air from an opening in the nozzle into the second passage to generate turbulence within the second passage,
wherein the decreasing cross-sectional area of the first and second passages increases a velocity of airflow as the airflow moves toward the outlet port.

2. The cleaning apparatus of claim 1, wherein the second housing defines an interior ramp within the second passage, the interior ramp defining a sloped surface that constricts the cross-sectional area of the second passage as the air flows toward the outlet port.

3. The cleaning apparatus of claim 2, wherein the interior ramp is configured to direct airflow in a rotational path synchronized with the turbulent flow generated by the spinning assembly.

4. The cleaning apparatus of claim 1, wherein the second housing includes a protective cone cover disposed concentrically about the nozzle within the second passage, and wherein the cone cover narrows an available flow path of the passage.

5. The cleaning apparatus of claim 4, wherein the protective cone cover prevents sheet-like debris from draping over the nozzle and prevents fiber-like debris from wrapping around the nozzle.

6. The cleaning apparatus of claim 1, wherein the first passage defines a first zone proximate the outlet port, the first and second passages define a second zone below the first zone having a reduced cross-sectional area relative to the first zone, and the second passage defines a third zone below the second zone having a greater cross-sectional area relative to the second zone defining a cleaning interface.

7. The cleaning apparatus of claim 1, wherein the second housing includes at least one vacuum vent configured to draw ambient air inward therethrough and into the second housing, and wherein the at least one vacuum vent balances positive and negative pressures within the cleaning apparatus.

8. The cleaning apparatus of claim 1, wherein the outlet port is configured to be coupled to a vacuum source.

9. The cleaning apparatus of claim 1, further comprising a cartridge assembly, the cartridge assembly including a cartridge housing and the spinning assembly, wherein a gap is provided between the nozzle and a lower opening in the cartridge housing, the gap being in communication with an outer surface of the second housing and defining a self-cleaning area through which air is drawn by a combination of the airflow expelled from the nozzle and vacuum pressure within the second housing.

10. The cleaning apparatus of claim 9, wherein the cartridge assembly includes an upper housing and a lower housing coupled to the upper housing, the lower housing having the lower opening through which the nozzle extends.

11. The cleaning apparatus of claim 1, further comprising at least one sensor disposed on or in the second housing and configured to detect motion and proximity to the nozzle.

12. The cleaning apparatus of claim 1, further comprising cleaning bristles disposed about a perimeter of the second housing, the cleaning bristles configured to contact a targeted cleaning surface during operation.

13. A vehicle interior cleaning system configured to couple to a robot arm, the system comprising:
a cleaning apparatus coupled to the robotic arm, the cleaning apparatus comprising:
a first housing defining a passage therethrough, the first passage having a cross-sectional area that decreases along a direction of airflow from a cleaning interface to an outlet port;
a second housing coupled to the first housing and defining a second passage therethrough, the second passage being in communication with the first passage and having a cross-sectional area that decreases along the direction of airflow from the cleaning interface to the first passage; and a cartridge assembly disposed within at least one of the first and second housing, the cartridge assembly having a cartridge housing and a spinning assembly at least partially disposed within the cartridge assembly, the spinning assembly having a nozzle configured to expel pressurized air into the second passage to generate turbulence within the second passage and
a controller configured to receive signals from at least one sensor and to control operation of the cleaning apparatus during a robotic cleaning sequence.

14. The vehicle interior cleaning system of claim 13, further comprising the at least one sensor, wherein the at least one sensor is disposed on or in the second housing to detect rotational status of the nozzle.

15. The vehicle interior cleaning system of claim 13, wherein the cartridge assembly includes an upper housing and a lower housing coupled to the upper housing, the lower housing having a lower opening through which the nozzle extends, wherein a gap is provided between the lower opening and the nozzle.

16. The vehicle interior cleaning system of claim 15, wherein the gap is in communication with an outer surface of the second housing and defines a self-cleaning area through which air is drawn by a combination of the airflow expelled from the nozzle and vacuum pressure within the second housing.

17. The vehicle interior cleaning system of claim 13, further comprising at least one vent in communication with interior volume of the second housing, the at least one vent configured to draw ambient air inward to balance positive pressure from the pressurized air and negative pressure from the vacuum source, thereby preventing the cleaning apparatus from locking onto an interior surface of the vehicle due to excessive vacuum pressure.

18. A cleaning apparatus, comprising:
a first housing defining a first passage therethrough;
a second housing coupled to the first housing and defining a second passage therethrough, the second passage being in communication with the first passage; and
a cartridge assembly disposed within at least one of the first and second housing, the cartridge assembly having a cartridge housing and a spinning assembly at least partially disposed within the cartridge housing, the spinning assembly having a nozzle configured to expel pressurized air from an opening in the nozzle into the second passage to generate turbulence within the second passage, wherein a gap is provided between a lower opening in the cartridge housing and the nozzle, the gap being in communication with an outer surface of the second housing and defining a self-cleaning area through which air is drawn by a combination of the airflow expelled from the nozzle and vacuum pressure within the second housing.

19. The cleaning apparatus of claim 18, wherein the cartridge assembly includes an upper housing and a lower housing coupled to the upper housing, the lower housing having the lower opening through which the nozzle extends, and wherein the gap is defined between the nozzle and periphery of the lower opening.

20. The cleaning apparatus of claim 18, wherein the cartridge assembly is removable.
